(19) United States
(12) Patent Application Publication
(10) Pub. No.: US 2011/0296043 A1
(43) Pub. Date: Dec. 1, 2011

(54) Managing Shared Sessions in a Shared Resource Computing Environment

(75) Inventors: Paul C. Sutton, Seattle, WA (US); Shahram Izadi, Cambridge (GB); Behrooz Chitsaz, Bellevue, WA (US)

(73) Assignee: Microsoft Corporation, Redmond, WA (US)

(21) Appl. No.: 12/791,731

(22) Filed: Jun. 1, 2010

(51) Int. Cl. G06F 15/16; G06F 3/048; G06F 15/173

(52) U.S. Cl. 709/229; 709/226; 715/771; 709/227

(57) ABSTRACT

Sharing and exchanging sessions between devices and users in a Shared Resource Computing (SRC) environment are disclosed. Example systems include a shared resource computing server and a plurality of peripheral devices. The SRC server (“SRC Box”) may include functionality configured to share and exchange sessions between the peripheral devices and the users, including functionality to map graphical representations of sessions to sessions and to map graphical representations of users to users, and functionality to display the representations of sessions and users within a graphical user interface. Alternate embodiments may also include functionality for transferring a saved session between devices.

### BACKGROUND

Processing and memory capabilities of desktop and laptop computers have increased such that conventional personal computers now have greater computing capability than is needed for many computationally simple tasks such as web browsing, e-mail, and word processing. This excess capability can enable a single computer to support multiple users simultaneously. By attaching several display devices, such as monitors, and several input devices, such as keyboards and mice, multiple users can share a single computer. Using one computer to support multiple users simultaneously is known as Shared Resource Computing (SRC). Schools and libraries in particular may benefit from SRC rather than conventional personal computer systems because computationally simple tasks are likely to predominate (e.g., web browsing rather than 3-D graphics) and the cost per seat of ownership and maintenance is less for a SRC system than an equivalent number of traditional computers.

A SRC environment may be distinguishable from a network, in the most general sense, in that a network entails a number of devices that are capable of stand-alone operation, coupled together for the purposes of communicating with one another. In a network, computational resources may be shared, but for convenience, generally not out of necessity. A network may be made up of a number of peer devices connected together in a variety of schemes, a server connected to a number of client devices, or some combination thereof. In general, if a client device is disconnected from a network, the client device is still capable of at least general purpose computing, if not running computationally intense applications or storing large amounts of data. Further, each device within a network is generally clocked individually, and a method is employed to synchronize timing across the network.

In contrast, SRC generally entails a single computing resource that is shared by a number of peripheral interface devices, where the peripheral devices have limited or no general purpose computing resources of their own. The peripheral devices in a SRC environment generally rely on a central computer or “SRC server” (“SRC Box”) for nearly all functionality, including computational functionality to run basic applications. Each peripheral device shares the central processing unit(s) (CPU) of the server, as well as the system memory and main bus(es) of the server. Each peripheral device is subject to the basic input output system (BIOS) of the server. In general, if a peripheral device in a SRC system is disconnected from the server, the device may lose the ability to run applications, or perform basic computational tasks. Further, the peripheral devices in a SRC system generally share the system clock of the server, which provides the timing for the SRC system.

Within a generalized example SRC system, users on the system may be collaborating in a common room. However, despite their proximity to one another, typical SRC systems do not allow users to share information or collaborate effectively.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This disclosure establishes mechanisms through which information may be shared between devices and users within a Shared Resource Computing (SRC) environment. In one example embodiment, a system for sharing and exchanging sessions between devices (and users) includes a SRC server (“SRC Box”) and multiple peripheral devices sharing a common computing resource, where the SRC Box generally provides the common computing resource. In an example, the server may comprise a processor, memory coupled to the processor, and a number of modules providing functionality for the sharing and exchanging of information. For example, the server may comprise a mapping module configured to map a graphical representation to each session operative on the SRC Box, and to map an avatar to each user of the system. The server may also comprise a display module configured to display the graphical representations within a graphical user interface (GUI). Further, the server may comprise a management module configured to associate a user to one or more of the sessions operative on the SRC Box, and to provide the user with access to resources stored on the SRC Box.

Another embodiment describes a method for sharing and exchanging information between devices (and users) in a shared resource computing environment. In one example, the method includes mapping a session operative on a SRC Box to a graphical representation of the session and displaying the graphical representation of the session within a graphical user interface (GUI). The method also includes mapping a user to a graphical representation of the user (the graphical representation is often referred to as an avatar). Further, the method includes determining a relationship of the user to the session and displaying the avatar within the GUI based on the relationship of the user to the session.

In a further embodiment, a method for sharing and exchanging information between devices (and users) in a shared resource computing environment includes accessing a session operative on a SRC Box by a user from a first device. The method also includes saving the accessed session to a saved session. In an example, saving the session includes capturing the current state of the user's interaction with the session and capturing the current state of the session. The method further includes transferring the saved session to a second device and accessing the saved session from the second device. In an example, the saved session is operative on the SRC Box when accessed at the second device.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of a logical layout of an illustrative architecture of a SRC system including a server and multiple peripheral devices.

FIG. 2 is a schematic diagram of a physical layout of the illustrative architecture of FIG. 1.

FIG. 3 is a block diagram of an illustrative SRC Box usable in the architecture of FIG. 1.

FIG. 4 is a schematic diagram illustrating a graphical user interface (GUI) display in two modes: a first mode showing a display of a desktop, and a second mode showing the desktop displayed as a graphical representation with a plurality of other graphical representations, according to an example embodiment.

FIG. 5 is a schematic diagram illustrating a display of a plurality of graphical representations of sessions or desktops. The diagram includes a plurality of avatars displayed based on their relationship to the sessions or desktops, according to an example embodiment.

FIG. 6 is a flowchart illustrating a method of managing sharing and/or exchanging sessions between devices in a SRC environment, according to an example embodiment.

FIG. 7 is a flowchart illustrating a method of sharing and exchanging a session between devices in a SRC environment, by saving and transferring the session, according to an example embodiment.

### DETAILED DESCRIPTION

The subject matter of this disclosure relates generally to sharing and exchanging sessions between devices and users, particularly in the context of shared resource computing. An illustrative shared resource computing (SRC) system may have only one computer (e.g., a device with a processor and a memory) but many user terminals (peripheral devices). Other SRC systems may include multiple computers each with one or more terminals. Descriptions of example SRC systems that describe a single SRC Box apply equally to systems having multiple SRC Boxes.

In one embodiment, a SRC system environment may be formed by coupling two or more SRC Boxes, where the functions and capabilities of the SRC system may be performed across or between the multiple SRC Boxes. For example, one SRC Box may exist in a school or workspace, and another SRC Box may exist in a remote datacenter accessible via the Internet, where these two SRC Boxes form a single SRC system, such that the embodiments described below may be used, for example, to share or exchange sessions between the different SRC Boxes, and users may or may not be aware that multiple SRC Boxes are involved.

Terminals in a SRC environment generally rely on a server for nearly all functionality, including basic computational functionality. Each terminal or peripheral device may share the core devices of the server, including central processing unit(s), system memory, main buses, system cache, and the like. Each peripheral device is subject to the basic input output system (BIOS) of the server. In general, if a peripheral device in a SRC environment is disconnected from the server, the device may lose the ability to run applications, or perform basic computational tasks. Further, the peripheral devices in a SRC environment generally share the system clock of the server, which provides the timing for the SRC system.

Users of a SRC system may have access to the same versions of the same applications, and corresponding working files. Management of the SRC system may be management of a single SRC Box, including updates to antivirus protection, maintaining user lists without domains, managing applications and content, controlling file sharing, performing backups, and the like. Additionally, an administrator may set up session-based work streams on a single machine, and suspend or save sessions and then resume them as part of maintenance routines, for example.

While each peripheral device is sharing the computing resources of a common computer, each terminal or peripheral device may be displaying a separate and independent session, a shared session, or multiple sessions. A session may include the unique interaction a user experiences when the user is signed in, or authenticated. For example, a session may include the user's individual desktop and associated individual settings, preferences, and applications. One example of a session may be a virtual machine running on the server, and displaying a desktop on a peripheral device. Another example of a session may be a remote access session operative on a peripheral device, such as Terminal Services (TS) Web Access, or Remote Desktop Services (RDS), both available from Microsoft Corporation of Redmond, Wash. In other examples, a session may be another type of similar user experience implemented using different technology. In each of these examples, the session is independent, while the computational resources that run the sessions are shared.

Access to a session by a user allows the user to perform tasks associated with the session (e.g., running applications, completing work assignments, consuming media content, etc.). Access to multiple sessions by a user allows the user to perform similar tasks under varying conditions (e.g., software testing, simulation, design tasks, etc.). Further, sharing a session between devices on a SRC system allows multiple users to share in, or contribute to, the unique experience of a single session. For example, multiple users may give input to the development of a project residing in a particular session, or an instructor may share an experience with a number of students, such that the experience is presented to each of the students in the same manner substantially simultaneously.

Managing the sharing and/or exchanging of sessions between devices in a SRC environment can include managing associations of users with sessions, granting or denying authentication and permissions of users to individual sessions, as well as ownership, access, and/or presence in public and private sessions, and the like. Additionally, managing sessions may include managing the transfer of sessions between the devices. However, management of complex issues such as these may be simplified by using a graphical user interface having familiar features and forms, for example.

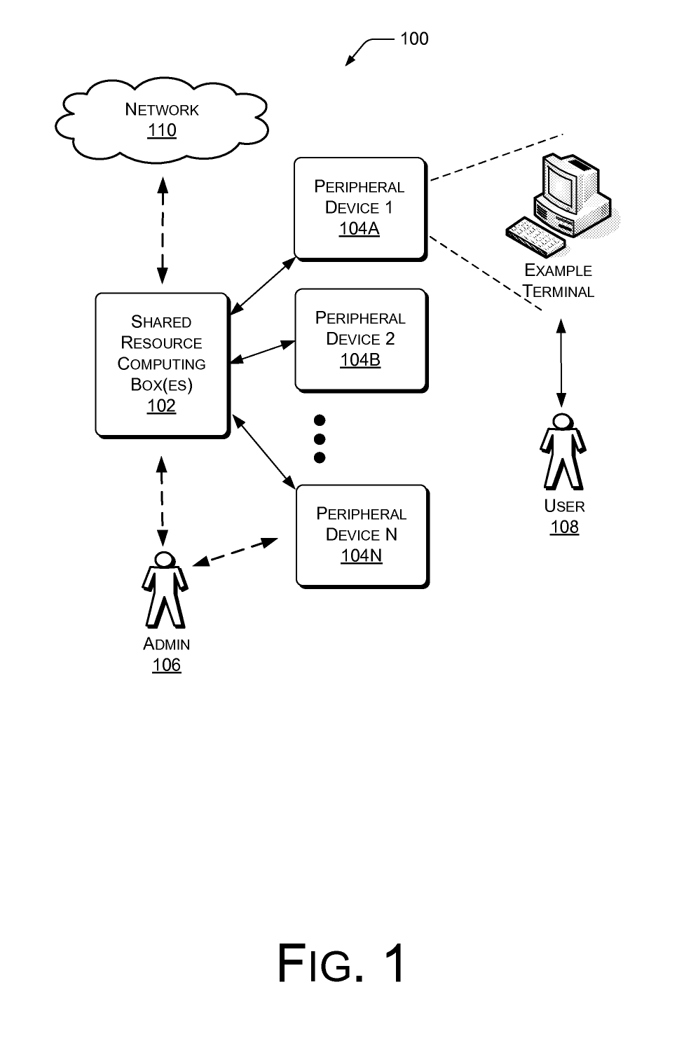

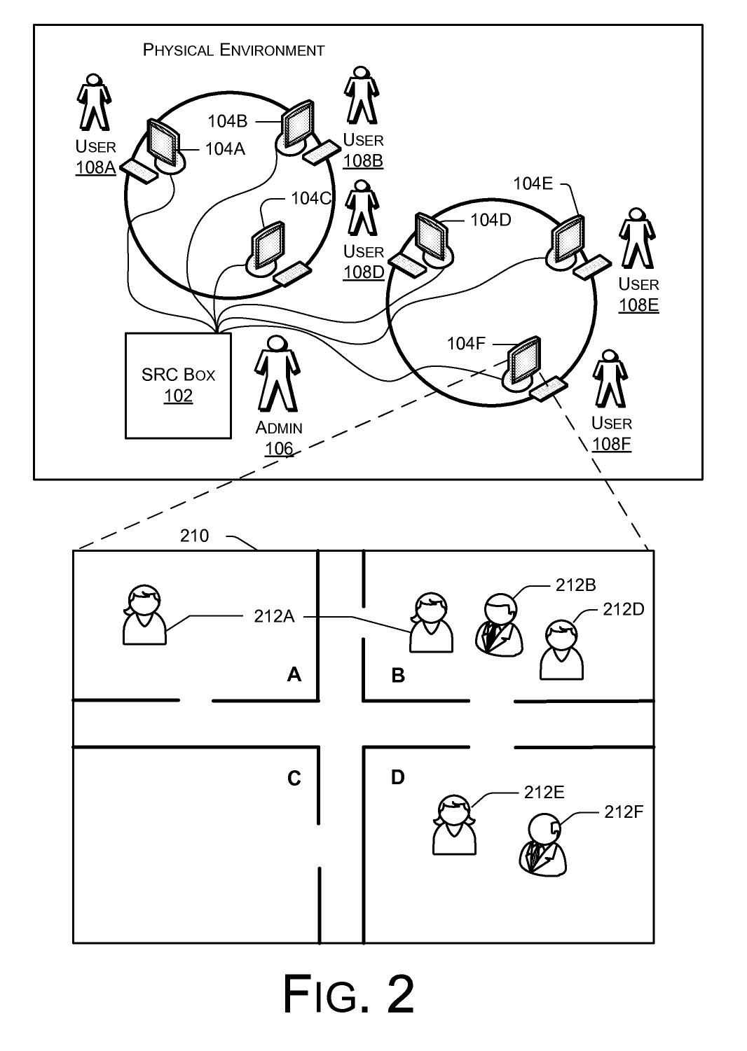

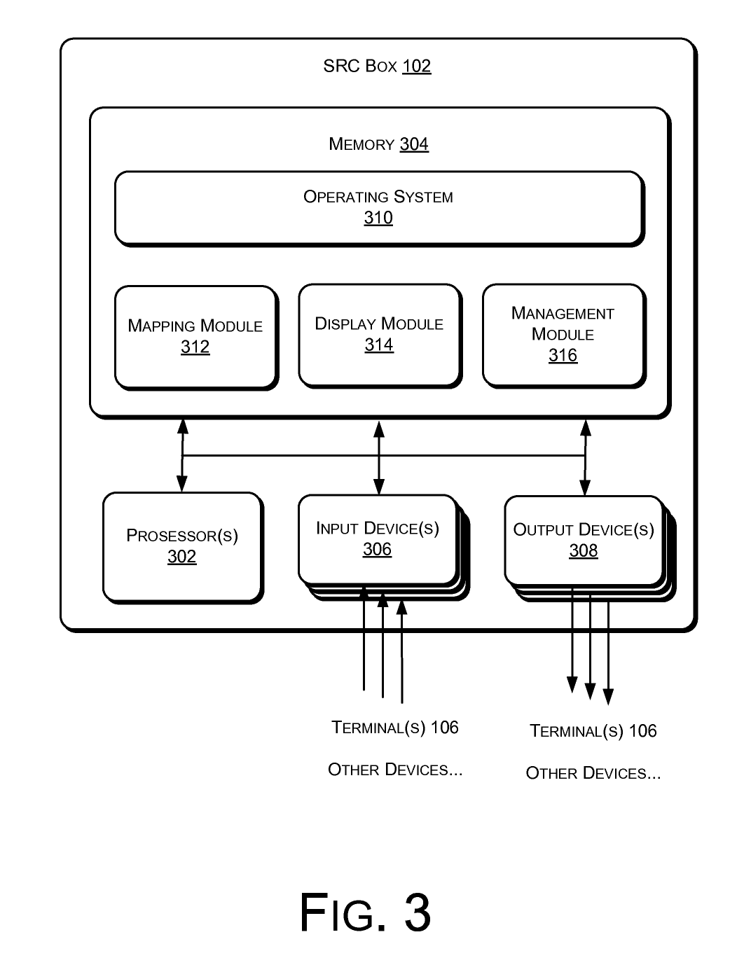

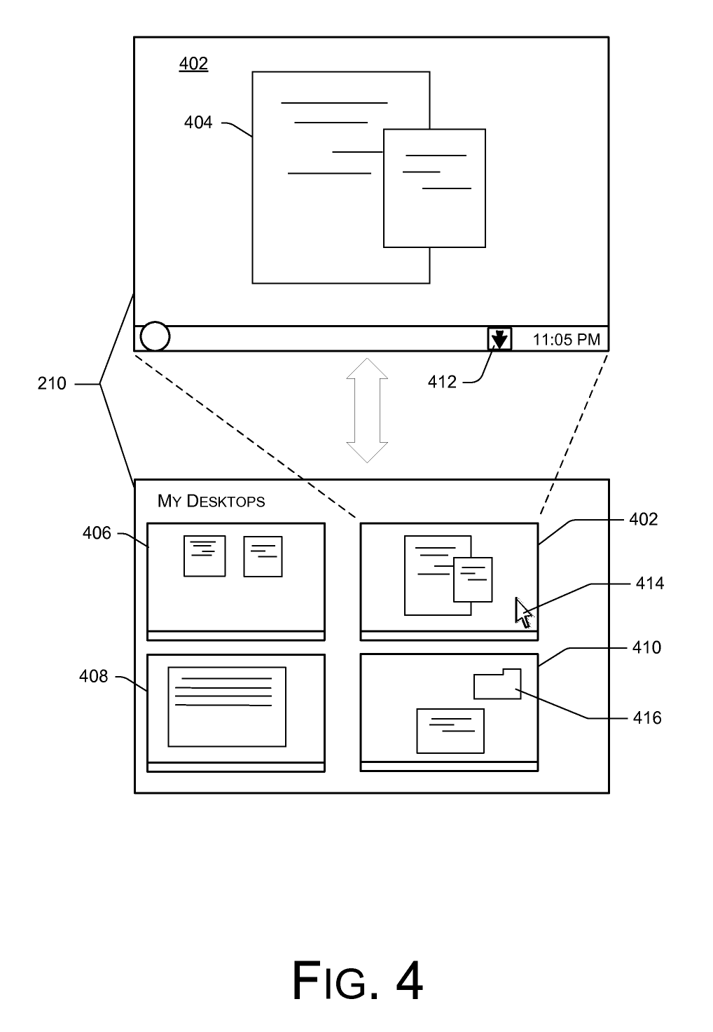

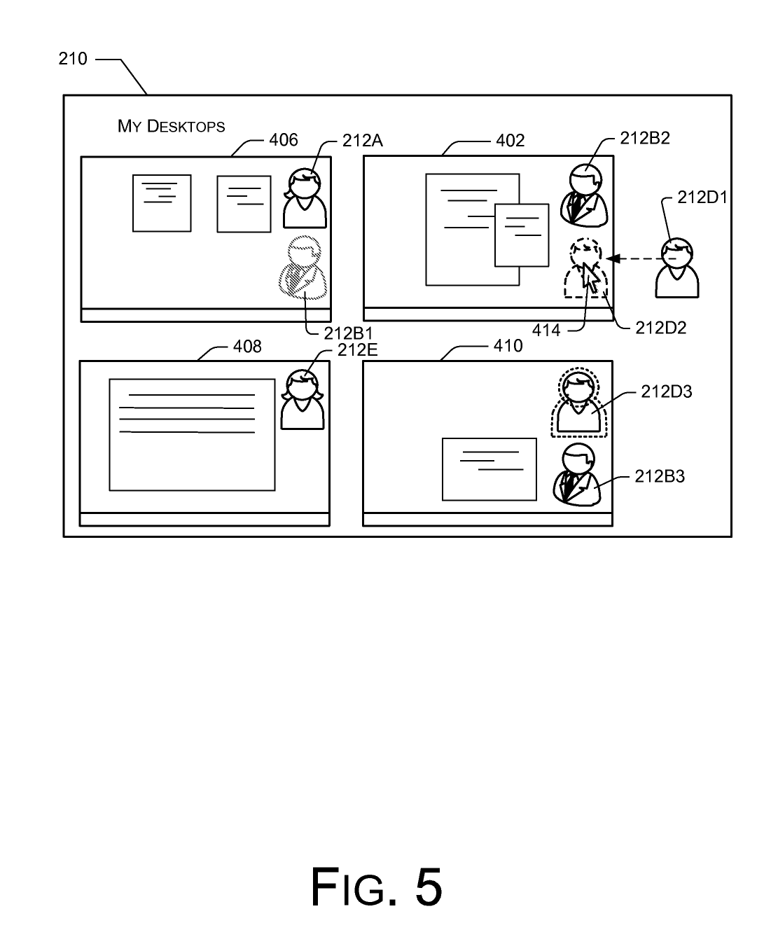

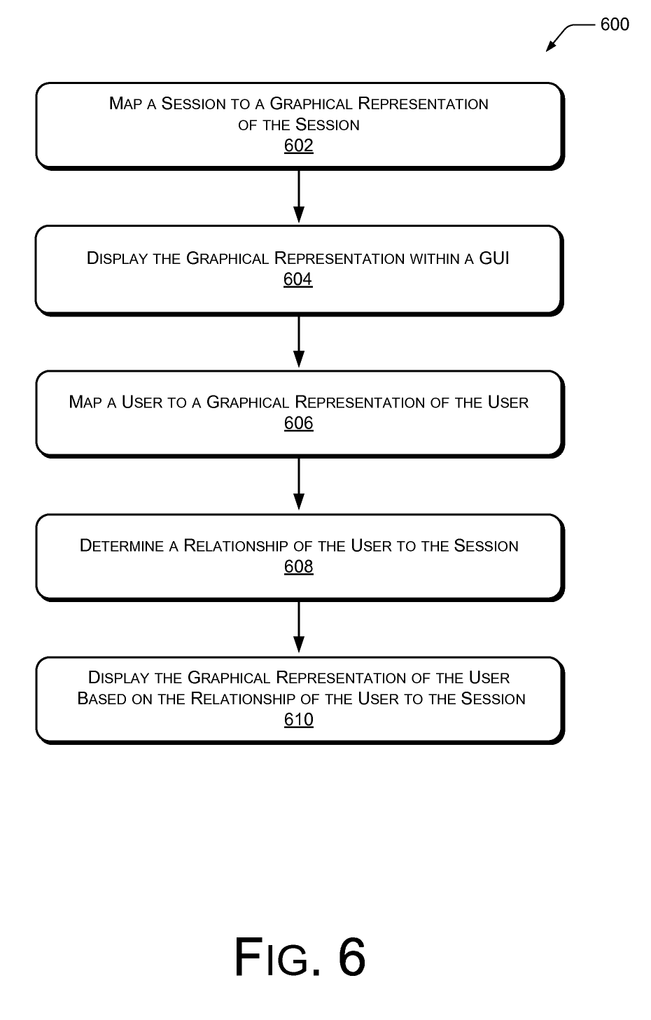

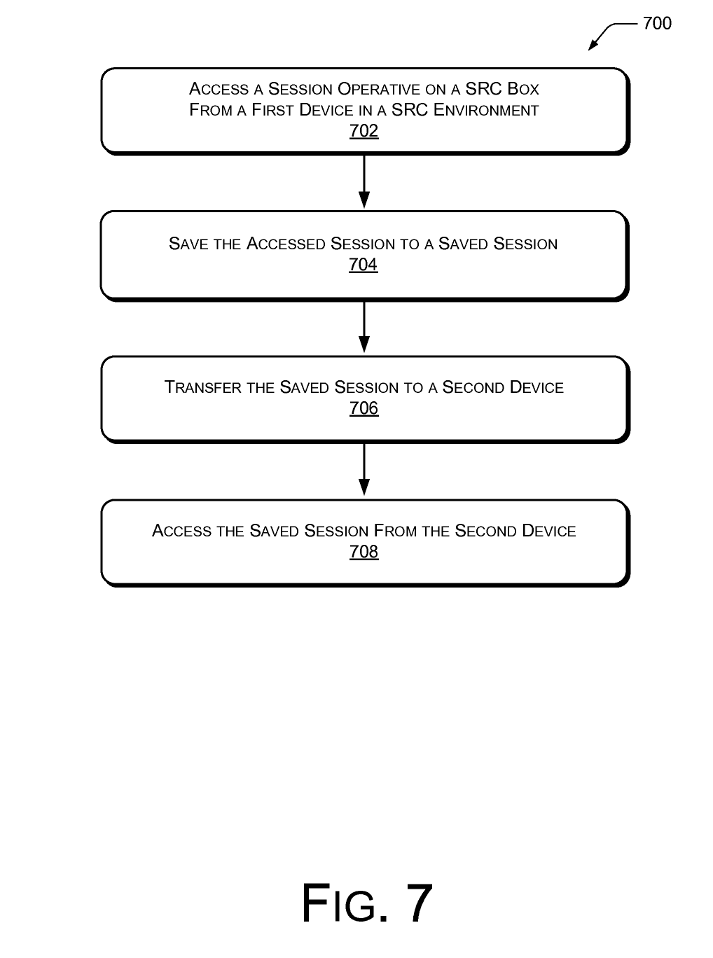

Systems and methods for sharing and exchanging sessions in a Shared Resource Computing (SRC) environment using a graphical user interface (GUI) are disclosed as follows. An example architecture for implementing the systems and methods is described with reference to FIGS. 1 and 2, the example architecture including example SRC environments. Embodiments of SRC Boxes are discussed with reference to a block diagram illustrated in FIG. 3, with discussion regarding functional modules that may be included in the SRC Boxes. Functionality of example embodiments are then discussed with reference to FIGS. 4 and 5, including functionality for displaying representations of sessions and users, and any associations between the sessions and users. Example methods for sharing and exchanging sessions between devices in a SRC environment are discussed with reference to FIGS. 6 and 7.

### Illustrative Shared Resource Computing (SRC) System

FIG. 1 is a schematic diagram showing elements and logical connections of an illustrative architecture 100 of a SRC system. The SRC system illustrated in FIG. 1 includes a SRC Box 102 and a number of peripheral devices (or terminals) 104. In one example, a SRC Box 102 has a direct connection to each peripheral device 104. In an embodiment, the direct connection between a peripheral device 104 and the SRC Box 102 is a wired connection, such as a universal serial bus (USB) connection, for example, or another type of local I/O connection. In an alternate embodiment, a direct connection between a peripheral device 104 and the SRC Box 102 may be a wireless connection, optical connection, or the like. In one alternate embodiment, direct connections between peripheral devices 104 and a SRC Box 102 are comprised of both wired and wireless connections. In another alternative embodiment, a peripheral device 104 may be a “thin client” connected via a local or wide-area network connection. However connected, each peripheral device 104 generally relies on the SRC Box 102 for general computing resources as explained herein.

A SRC Box 102 in an example SRC system may be a conventional desktop or laptop personal computer (PC) or a virtual machine running on such a PC or in a datacenter. Other examples of SRC Boxes include conventional Web servers, set-top boxes, gaming consoles, and the like. Although sometimes termed a “server,” the SRC Box 102 is not necessarily connected to a network, and need not be for the purposes of this discussion. However, in some example embodiments, the SRC Box 102 may be connected to a network 110, such as an intranet, the Internet, and the like.

By way of example, an administrator 106 is illustrated as having access to the SRC Box(es) 102 and also to a peripheral device 104. An administrator 106 may manage the SRC system from the SRC Box 102 and/or use the SRC Box 102 as a conventional computer. If a SRC system is deployed in a classroom setting, the administrator 106 may be a teacher rather than an IT technician. The administrator 106 may have access to advanced functionality on the SRC system, which may include the rights to system level configurations, the authentication of users, granting or denying access to resources on the system, and the like.

FIG. 2 shows a schematic diagram of a physical layout of the illustrative architecture 100 of FIG. 1. The illustration in FIG. 2 shows a SRC system that may be in a conference room at a business, a school setting, or the like. In a home setting, a SRC system may include a single computing device, for example, a conventional desktop computer that functions as the SRC Box 102 with a multitude of other devices as the peripheral devices 104. Similarly, in a business setting a company may have a single computing device or a virtual machine in a datacenter that functions as the SRC Box 102 for a group of employees who each have a terminal 104 at their respective workstations. Depending on the size of the company and the number of employees, there may be multiple SRC Boxes 102 coupled together by local input/output (I/O) connections, network connections, or both, forming an intranet, a server farm, or other local or wide area network.

As described above, an example SRC system as shown in FIGS. 1 and 2 also includes several user terminals 104. Six user terminals 104A, 104B, 104C, 104D, 104E, and 104F are shown in FIG. 2. However, a greater or lesser number of terminals 104 may be connected to the SRC Box 102. The terminals 104 may comprise input and output devices without separate processors or memory. In other implementations, the terminals 104 may be thin clients with limited processors and/or memory, or other devices capable of acting as a terminal 104. While peripheral devices 104 have been described as having limited or no functionality when not connected to a server 102, in alternate embodiments the peripheral devices 104 may have additional functionality that is generally not used when the peripheral device 104 is connected to the SRC Box 102. Thus, in some embodiments, such devices as laptops, terminals with a monitor and keyboard similar to a desktop computer, a set-top box coupled to a television set, etc. may be used for terminals 104. In other embodiments, cell phones, personal digital assistants (PDAs) and the like may be used for terminals 104.

Each user terminal 104 generally provides input and output devices (e.g., a keyboard and a monitor) for a user 108. Users 108A, 108B, and 108D-108F are shown in FIG. 2 using the terminals 104A, 104B, and 104D-104F respectively. In the example above, a user 108 may be a student, if the SRC system is deployed in a classroom setting. In one embodiment, each user 108 is authenticated to the SRC system. In an embodiment, as illustrated in FIGS. 1 and 2, one of the users may also be an administrator 106. In that example, the user may login to one of the peripheral devices 104 using an additional level of authentication than is required for a user login. For example, an additional level of authentication may include an additional username and password. Using an additional level of authentication may authenticate a user 108 as the administrator 106 for the SRC system. Alternatively, the user 108 may login using a single username and password, which is authenticated to provide that user 108 with administrator access.

In an embodiment, the SRC system is configured to share and exchange sessions between peripheral devices 104. For example, the SRC system can be configured to allow one user to share a session that the user is working on with a second user on the system. In an example embodiment, the SRC system is configured to generate a GUI 210 to display representations of the sessions operative on the SRC system. In one example, the GUI 210 represents the sessions using graphical representations of the sessions. For example, the graphical representations of the sessions may resemble rooms (i.e., rooms within a school, or other building) as shown in the illustration of FIG. 2. In other embodiments, the graphical representations may appear in other forms, such as small desktops (as illustrated in FIGS. 4 and 5), or the like.

The GUI 210 may be displayed on one or more of the peripheral devices 104. For example, FIG. 2 illustrates a GUI 210 that may be displayed on peripheral device 104F. In the illustrated example, sessions are represented as rooms A, B, C, and D. In alternate embodiments, the rooms may appear differently within the GUI 210. For example, the rooms may be displayed in a manner to indicate ownership of the session by a user (e.g., with color, borders, labels, line styles, etc.).

In an embodiment, the SRC system is further configured to map each user of the system to a graphical representation 212 of the user, generally referred to as an avatar. The avatars 212 may be displayed adjacent to or within the graphical representations of the sessions displayed within the GUI 210, to show association with the sessions, for example. As shown in FIG. 2, avatars 212A, 212B, 212D-212F are mapped to users 108A, 108B, 108D-212F, respectively, and are shown within graphical representations of various sessions. Avatar 212A is shown within sessions (“rooms”) A and B, which may indicate that user 108A has access to sessions A and B. As is discussed below, in alternate embodiments, an avatar 212 may be displayed within a graphical representation of a session in a manner to indicate the user's relationship to the session.

In an embodiment, the graphical representations of the sessions and the avatars 212 may be used to share and exchange sessions via the GUI 210. For example, they may be used to establish relationships between users 108 and sessions, including authentication and/or access to the sessions by the users 108. In one embodiment, a user 108 establishes a relationship to a session by moving the avatar 212 representing the user 108 within the GUI 210 to the representation of the session resembling a room. Accordingly, the user 108 may terminate a relationship with a session by moving the avatar 212 away from the representation of the session resembling the room. Thus, in an embodiment, as illustrated in FIG. 2, a user 108 may establish and terminate relationships with sessions by moving the user's avatar 212 from room to room within the GUI 210. As the avatar 212 is moved into a room, a relationship (e.g., access, rights, privileges, authentication, etc.) may be established with the user 108 to the session represented by the room. In alternate embodiments, additional or fewer relationship components may be established with the user 108 when the avatar 212 is moved into a room.

The user 108 may move the avatar 212 using a pointing device such as a mouse, touch pad, touch screen, a gesture, keystroke(s), or the like. In other embodiments, other techniques may be used to establish or terminate relationships between a user 108 and a session operative on the SRC Box.

### Illustrative Server and Functionality

FIG. 3 shows a block diagram of an illustrative SRC Box 102. An example SRC Box 102 may include one or more processor(s) 302, and memory 304 coupled to the processor(s) 302. The processor(s) 302 may be implemented as appropriate in hardware, software, firmware, or combinations thereof. Software or firmware implementations of the processor(s) 302 may include computer- or machine-executable instructions written in any suitable programming language to perform the various functions described.

Memory 304 may store programs of instructions that are loadable and executable on the processor(s) 302, as well as data generated during the execution of these programs. Depending on the configuration and type of SRC Box 102, memory 304 may be volatile (such as RAM) and/or non-volatile (such as ROM, flash memory, etc.). The SRC Box 102 may also include additional removable storage and/or non-removable storage including, but not limited to, magnetic storage, optical disks, and/or tape storage. The disk drives and their associated computer-readable media may provide non-volatile storage of computer readable instructions, data structures, program modules, and other data.

The example SRC Box 102 may also include multiple input devices 306 and multiple output devices 308 for interfacing with peripheral devices 104. Input signals from peripheral devices 104 may be handled by input devices 306, and output signals for peripheral devices 104 may be handled by output devices 308. In alternate embodiments, input devices 306 and output devices 308 may also handle input and output signals respectively for other devices on the system. For example, each terminal may include input devices such as a keyboard, mouse, camera, pen, voice input device, touch input device, stylus, and the like, and output devices such as a display, monitor, speakers, printer, etc. All these devices are well known in the art and need not be discussed at length.

The SRC Box 102 of FIG. 3 illustrates an example architecture of the above components residing on one device. Alternatively, these components may reside in multiple other locations, servers, or systems. For instance, all of the components may exist on a remote server. Furthermore, two or more of the illustrated components may combine to form a single component at a single location. The illustrated components may also reside in a SRC Box 102 without a connection to a network, such as a stand-alone desktop or laptop computing device.

In one embodiment, modules configured to provide functionality to the SRC system may be stored in the memory 304 and executable on the processor(s) 302. For example, an operating system 310 may be stored in the memory 304 and executable on the processor(s) 302. Additionally, other modules stored in the memory 304 and executable on the processor(s) 302 may include a mapping module 312, a display module 314, and a management module 316. In alternate embodiments, fewer modules may be present or additional modules may be stored in the memory 304 to provide functionality to the SRC system. Although illustrated in FIG. 3 as being stored in memory 304, it is recognized that mapping module 312, display module 314, and management module 316, or portions thereof, may be implemented using any form of computer-readable media that is accessible by processor(s) 302. Computer-readable media may include, for example, computer storage media and communications media.

Computer-readable storage media includes volatile and nonvolatile, removable and non-removable media implemented in any method or technology for storage of information such as computer-readable instructions, data structures, program modules or other data. Memory 304 is an example of computer-readable storage media. Additional types of computer-readable storage media that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may accessed by the SRC Box 102.

In contrast, communication media typically embodies computer readable instructions, data structures, program modules, or other data in a modulated data signal, such as a carrier wave, or other transport mechanism.

If included, a mapping module 312 may be configured to map a graphical representation to each of multiple sessions operative on the SRC Box 102. In one embodiment, the graphical representations may resemble rooms (as illustrated in FIG. 2). For example, a group of sessions operative on the SRC Box 102 may be represented by a graphical rendering of a school building, or another sort of building, with the individual sessions represented as rooms within the building. In alternate embodiments, the graphical representations may be displayed in other forms. In one example, the graphical representations represent small desktops (as illustrated in FIGS. 4 and 5).

Additionally or alternatively, the mapping module 312 may be configured to map an avatar 212 to each user 108 of the SRC system. In one embodiment, the mapping module 312 maps an avatar 212 to the user's profile or account on the system. In alternate embodiments, the mapping module 312 maps an avatar to each user 108 by other methods.

In one embodiment, the mapping module 312 may be configured to create the avatar 212 based on generic features, for example. In another embodiment, a user 108 or an administrator 106 may create the avatars 212. In other embodiments, the avatars 212 may be created in another way, for example, the avatars 212 may be imported from a network 110 location, such as the Internet. In any case, the mapping module 312 may be configured to map an avatar 212 to a user 108, such that each user 108 has a representative avatar 212.

Typically the avatars 212 will be uniquely distinguishable from each other to the SRC system, since relationships of users 108 to sessions (such as access, rights, and authentication, for example) may be affected by moving or dragging an avatar 212 within the GUI 210. This may be accomplished by assigning unique identification tags, colors, symbols, or other identifiers (such as a user's name or username) to the avatars 212, for example. Generally, the avatars 212 will also be distinguishable from each other to the users, so that the users know which user may be associated to a particular session, or which user may be requesting permissions with regard to a session. In one embodiment, each avatar 212 has a unique appearance. In other embodiments, an avatar 212 may be unique in some other way. For example, an avatar 212 may have a unique animation. In one embodiment, an avatar 212 may be based on some physical characteristic of the user 108. For example, an avatar 212 may appear to have a same gender, hair color, clothing color, or the like, of the user 108. Additionally, the avatar 212 may appear to have accessories similar to those of the user 108, for example, a hat, a pair of glasses, or the like. In one embodiment, an avatar 212 may be based on an image of the user 108, for example, an image from a camera, an image file, or the like. In another embodiment, an avatar 212 may include a display of the user's name (actual name or username) below or next to the avatar 212.

If included, a display module 314 may be configured to generate a GUI 210, and to display the graphical representations of the sessions operative on the SRC Box 102 within the GUI 210. In one embodiment, the display module 314 may be configured to display only the graphical representations of those sessions to which a user has been granted access or invited. Additionally, the display module 314 may be configured to display the avatars 212 within the GUI 210. In one embodiment, the display module 314 displays the avatar 212 mapped to a user 108 within the GUI 210 when the user 108 is associated to one or more of the sessions operative on the SRC Box 102.

In an embodiment, a management module 316 may be included in the SRC Box 102. For example, the management module 316 may be configured to associate a user 108 to one or more of the sessions operative on the SRC Box 102. Accordingly, the associations and/or relationships (e.g., access, rights, privileges, authentication, etc.) as described above may be performed by the management module 316. In alternate embodiments, at least some of the associations and/or relationships may be performed by other elements of the system.

In one example, the management module 316 may be configured to associate the users 108 to a session without requiring a user name or password. For example, in one embodiment, the management module 316 associates a user 108 to a session when the avatar 212 representing the user 108 is moved (or dragged) to a graphical representation of the session. Accordingly, the user 108 may be associated to more than one session if the avatar 212 representing the user 108 is moved (or dragged) to multiple sessions. In one example, the management module 316 is configured to associate the user 108 to multiple sessions in response to a single user action (e.g., such as a login). In alternate embodiments, the user 108 may be associated to one or more sessions through other techniques (e.g., queues, tables, databases, etc.). Accordingly, association may be automatic or semi-automatic.

In one embodiment, the management module 316 is configured to create a new session operative on the SRC Box 102 based on input from a user 108 (e.g., mouse click, keystrokes, gestures, touch screen, pen, mouse movements, etc.). In one example, the user 108 is automatically associated to the new session. In alternate embodiments, the user 108 may determine associations, access, permissions, and the like as part of creating the new session. For example, an administrator 106 may create a new session for another user 108 on the SRC Box 102, associating the user 108 to the new session and making access and permission determinations regarding one or more other users to the new session as well. In other embodiments, determining associations, access, permissions, and the like is performed separately from creating a new session.

### Example Functionality

### Display of Sessions

A user 108 may be associated to more than one session at a time. Accordingly, management of sessions using a graphical user interface (GUI) 210 may include managing which of the session(s) that the user is associated to are open at a time.

FIG. 4 is a schematic diagram illustrating a GUI 210 in two configurations, showing an example of session management. The GUI 210 may be displayed on a peripheral device 104. In the upper portion of FIG. 4, a session 402 (or desktop) is shown maximized on a GUI 210. With the session 402 in a maximized form, the session is open for use by a user 108. The session 402 may include an operating system, and may have one or more applications operational on the session, as illustrated by the example application 404.

In the lower portion of the illustration of FIG. 4, the session 402 is shown reduced to a graphical representation of the session 402, displayed along with other graphical representations of sessions (406, 408, and 410) that the user 108 is associated to. With the session 402 in reduced form, the session 402 is not open for use by the user 108. However, in some embodiments, one or more applications may still be operative on the session 402 while the session 402 is reduced to a graphical representation. Additionally, the session 402 may be associated to one or more other users, and open for use by another user on a separate peripheral device 104.

For example, a session 402 may be associated to (shared by) users 108B and 108C, with both users having equal permissions to access, read, or write to the session 402. In one embodiment, both users 108B and 108C may have the session 402 open (maximized) on their respective peripheral devices 104B and 104C. At that time, both users may make changes to the session 402, or make changes to applications operational on the session 402.

However, at some point, the display of session 402 may be reduced to a graphical representation on the GUI 210 of peripheral device 104B, while the session 402 continues to be displayed in a maximized form on the peripheral device 104C. Accordingly, user 108B may be unable to make changes to the session 402, or applications operational on the session 402, while the session 402 is in a reduced, graphical representation state. However, user 108C may still be able to make changes to the session 402 during that time, or to the applications operational on the session 402.

In alternate embodiments, various actions may result in a display of a session 402 being reduced to a graphical representation on a GUI 210. In alternate embodiments, the GUI 210 may default to either displaying a single session or multiple sessions associated to the user when the user logs on to the SRC system. For example, this may be a user preference setting, or the like. In one embodiment, the display module 314 is configured to display, within the GUI 210, the graphical representations of each session that a user is associated to, in response to a user input. If the user input is received while a session 402 is displayed in a maximized form, then the display of session 402 is reduced to a graphical representation of the session.

For example, in one embodiment, the session 402 may include an icon 412 (as shown in FIG. 4), or other user input control. When the user 108 selects the icon 412, the display module 314 reduces the display of the session 402, and displays the graphical representations of each session that the user is associated to (including session 402) within the GUI 210 (as shown in the lower portion of FIG. 4). In other embodiments, other actions may be taken by the user 108 to reduce the session 402 to a graphic representation (e.g., keystrokes, gestures, touch screen, pen, mouse movements, etc.).

Conversely, in alternate embodiments, various actions may result in a display of a graphical representation of a session 402 being expanded to a display of the maximized session 402 within the GUI 210. With the session displayed in maximized form, the user 108 is able to view the session 402, and perform changes to the session 402 or to any applications operative on the session 402, as long as the user 108 has the permissions to do so. In one embodiment, the display module 314 is configured to display, within the GUI 210, one of the sessions that the user is associated to in a maximized manner in response to a user input. For example, the user input may comprise a user selection of a graphical representation, where the graphical representation is mapped to the session to be maximized.

In one embodiment, as shown in FIG. 4, a user may select one of the graphical representations of sessions being displayed within the GUI 210 with a mouse pointer 414. For example, the user 108 may move the mouse pointer 414 to a graphical representation of the session using an input device. In alternate embodiments, the user 108 may make the selection by mouse click, or by hovering over the graphical representation, or by a drop-down menu, or the like. In other embodiments, the user 108 may select a graphical representation by other techniques (e.g., keystrokes, gestures, touch screen, pen, mouse movements, etc.). In an embodiment where the sessions are represented as “rooms,” the user 108 may move his avatar 212 into a room, for example, to select a session to be displayed in a maximized form. In one embodiment, a user 108 may switch between displayed maximized sessions that the user 108 has access to by some action by the user. For example, the user 108 may switch between maximized desktops using a combination of keystrokes, a mouse-click on an icon, selection from a drop-down menu, touch screen, gestures, and the like.

Thus, in an example scenario, a user 108 logs into the SRC system and a GUI 210 presents the user 108 with a display of the last session that the user had open when he logged out previously, (assuming this is a preference that has been implemented). The user 108 enters an input (e.g., keystrokes, a mouse-click on an icon, selection from a drop-down menu, touch screen, gestures, and the like) within the open session, and the session minimizes to a graphical representation of the session (displayed as a “room,” a “mini-desktop,” or the like). The GUI 210 displays the graphical representation of the session along with graphical representations of other sessions with which the user 108 has access. The user then selects one of the graphical representations of sessions with a user input (e.g., keystrokes, a mouse-click, selection from a drop-down menu, touch screen, gestures, and the like) and the selected session maximizes to be displayed on the GUI 210 as the open session. This example describes one of many scenarios possible within alternate embodiments. A person having skill in the art will recognize many variations, given the disclosure herein.

In one embodiment, the user 108 may be associated with more sessions than fit on a single screen of the GUI 210 at once. In that case, the user 108 may scroll through the sessions on the GUI 210, using one or more techniques for scrolling on a display (e.g., keystrokes, gestures, touch screen, pen, mouse movements, etc.). In alternate embodiments, the graphical representations may scroll in various ways (e.g., horizontally, vertically, free-form scrolling, 3D page-image scrolling, flip-book style, and the like). Accordingly, when the user 108 has located a session of interest through scrolling, the user 108 may select the session to maximize it, and open it for viewing and/or changing.

In one embodiment, the display module 314 is configured to display the graphical representations of the sessions to indicate a relationship with the user 108 to the session. For example, if several graphical representations of sessions are displayed on a GUI 210, each of the graphical representations may be displayed in a manner to indicate ownership of each of the sessions. A session may be displayed in one manner to indicate that a user 108 owns the session, or in another manner to indicate that the user 108 has created the session. Other sessions may be displayed in other manners to indicate that the session is owned or was created by other users. Further, a session may be displayed in one manner to indicate that the user 108 has been invited to join the session, or a session may be displayed in another manner to indicate that the user 108 has accepted an invitation to join the session (or has joined the session).

Manners of displaying sessions to indicate a relationship of a user 108 to the session may include the use of colors, highlighting, animation, transparency, size, line types, and the like. For example, sessions owned by a user 108 may be displayed larger than other sessions on the user's GUI 210. Alternately or additionally, sessions that the user 108 is invited to may be displayed in a semi-transparent form, while sessions that the user 108 has joined may be displayed in a solid or bolded form. One skilled in the art will recognize that there are many variations of display forms that may be used to indicate relationships, including combinations of the above mentioned forms, as well as others.

In an alternate embodiment, the mapping module 312 may be configured to map a representation of a folder 416 to a folder operative on the SRC Box 102. Accordingly, the display module 314 may be configured to display the representation of the folder 416 within the GUI 210, (as shown in FIG. 4). For example, the representation of the folder 416 may be displayed within a “room” or a “desktop” representing a session. Additionally or alternately, the representation of the folder 416 may be displayed in another manner to represent the folder. In one embodiment, a user 108 may have access and/or permissions to a folder on the SRC Box 102 using the same methods discussed above with respect to access and/or permissions to sessions on the SRC Box 102 (e.g., moving or dragging an avatar 212, etc.).

### Display of Avatars

In an embodiment, the display module 314 may be configured display an avatar 212 proximate to a graphical representation of a session within the GUI 210 when a user 108 is associated to the session. For example, the avatar 212 may be displayed next to, or within each graphical representation of a session with which the user 108 is associated (illustrated in FIGS. 2 and 5). A user 108 may be associated to a session when the user has established a relationship to the session as described above, for example. In other embodiments, the user 108 may be associated to a session when another user invites the user 108 to a session, or grants the user 108 rights or permissions with regard to a session, for example. As discussed above, a user 108 may be associated with multiple sessions. Accordingly, the avatar 212 representing the user 108 may be displayed multiple times within the GUI 210, with respect to the multiple sessions. In alternate embodiments, the display module 314 may be configured to display an avatar 212 within the GUI 210 in response to other actions, for example, an input by a user (e.g., login).

In alternate embodiments, the display module 314 may be configured to display the avatars 212 in various ways for indication purposes. In an embodiment, the display module 314 may be configured to display an avatar 212 in an emphasized manner when the user 108 is authenticated to or has access to the session with which the user 108 is associated. This is discussed with reference to FIG. 5, showing “desktop” graphical representations of sessions, and applies equally to the “room” graphical representations of sessions shown in FIG. 2, or other like representations. In FIG. 5, the avatars 212A, 212B2, 212B3, 212D3, and 212E are shown displayed in an emphasized manner. Displaying an avatar 212 in an emphasized manner may include the use of colors, highlighting, animation, transparency, size, line style and/or weight, and the like. For example, avatar 212D3 is shown displayed with highlighting and/or animation. In another embodiment or in addition to the above, the current user's own avatar may be displayed in an emphasized manner, so as to be unique and distinguishable from the avatars of other users.

In another embodiment, the display module 314 may be configured to display an avatar 212 in a de-emphasized manner when the user 108 is not authenticated to or does not have access to the session with which the user 108 is associated. This is shown in FIG. 5, where avatars 212B1 and 212D2 are displayed in a de-emphasized manner. Displaying an avatar 212 in a de-emphasized manner may also include the use of colors, highlighting, animation, transparency, size, line style and/or weight, and the like. For example, avatar 212D2 is shown displayed with transparency and/or dashed lines.

In an example scenario, a user 108D uses a GUI 210 to drag an avatar 212D1 representing the user 108D into a graphical representation 402 of a session. This dragging may have the effect of associating the user 108D to the session, but may not result in the user 108D being authenticated to the session or having access to the session. Thus, the avatar (shown as 212D2) may be displayed in a de-emphasized manner. For instance, the user 108D may not have the correct rights or permissions to the session. In this scenario, the user 108D may create a request to the administrator 106 for access to the session, for example, by the dragging. If the user 108D subsequently receives access to the session, the avatar 212D2 may then be displayed in an emphasized manner.

In an alternate example, another user (for example, user 108A) may drag the avatar 212D1 into a graphical representation 402 of a session. This dragging may have the effect of inviting the user 108D to a session owned/controlled by the user 108A. The avatar representing user 108D may be displayed in a de-emphasized manner (as shown by 212D2) until the user 108D accepts the invitation and joins the session, at which point the avatar may then be displayed in another manner to indicate participation in the session. Further, the user 108A may drag the avatar representing the user 108D out of the graphical representation 402 of the session, thereby revoking access to the session.

In another example scenario, an administrator 106 drags the avatar 212D3 representing a user 108D into a graphical representation 410 of a session. This dragging may have the effect of associating the user 108D to the session, and may also have the effect of granting the user access to the session and/or authenticating the user to the session. In this scenario, the avatar 212D3 representing the user 108D may be displayed in an emphasized manner, indicating the access rights and/or authentication of the user 108D to the session. Alternately, the avatar may be displayed in a de-emphasized manner, indicating that the user 108D was merely invited to participate in a session, but that the user 108D has not yet accepted the invitation.

In one embodiment, avatars 212 may be dragged using a mouse pointer 414, or the like. In other embodiments, avatars 212 may be moved by other techniques (e.g., keystrokes, gestures, touch screen, pen, mouse movements, etc.).

### Managing Sessions

In alternate embodiments, users may perform various session management tasks by alternate methods. Session management tasks may include saving a session, deleting a session, creating a new session, viewing information about sessions, and the like. For example, in one embodiment, a user 108 can save a session, including projects and the like operative within the session, by a selection from a menu within the session. In alternate embodiments, other user inputs may be used to save a session, (e.g., keystrokes, icons, gestures, touch screen, pen, mouse movements, etc.). Alternatively or additionally, a user 108 may perform session management tasks on one session while the user is in another session.

Additionally, other session management tasks as described above (and others) may be performed similarly in various embodiments. In alternate examples, users may delete a session that is no longer needed or create a new session by making a selection from a menu available within a current session. Various options may be available to the user when deleting a session or creating a new session depending on the rights held by the user 108 performing the task. For example, a user 108 may or may not have permission to permanently delete a session, but may have permission to send a session to a “recycle bin.” Also, a user 108 may have permission to create a session, but may or may not have permission to create a shared session.

Further, as described below, in an embodiment, a user 108 may view information relating to a session. The information may be historical information, or real time events, for example.

### Notifications

In one embodiment, the management module 316 may be configured to log events associated with one or more sessions operative on the SRC Box 102. In one example, the display module 314 is configured to display notifications to at least one user 108 based on the events logged by the management module 316.

For example, in an embodiment, the management module 316 may be configured to log events including: when a session is opened by another user; when a change is made to a session since the session was last opened by the user 108; when a session is shared between one or more other users; and when an application is opened within a session by another user. In alternate embodiments, the management module may be configured to log fewer events, or other or additional events to those listed. The management module 316 may essentially keep track of the activities occurring on the SRC Box 102 with respect to sessions operative on the SRC Box 102, and record the activities.

The recorded activities may be displayed to the users on the SRC Box 102, for example, in the form of notifications to the users. In one embodiment, the display module 314 displays notifications to a user 108 regarding all activities relative to the sessions that the user 108 is associated to. In another embodiment, the display module 314 displays notifications to a user 108 of all activities occurring on the SRC Box 102. For example, a user 108 may also be an administrator 106, the administrator 106 receiving notifications regarding all activities. In alternate embodiments, a user 108 may configure the display module 314 to display only selected notifications (e.g., when a session is being shared by one or more other users, or when specific changes are made to a session or an application operative on the session, etc.). In other embodiments, a user 108 may select the level of detail that the user 108 receives in the form of notifications. In one embodiment, a user 108 may only receive notifications according to the permissions held by the user 108.

The display module 314 may display the notifications in a number of ways to the user 108. For example, the notifications may be displayed in the form of a running history, individual pop-up notices, a ticker stream (for example running at the bottom of a display), a message thread, or the like. In one embodiment, the user 108 may configure the display module 314 to display notifications to the user in a selected format.

### Illustrative Processes

For ease of understanding, the processes discussed in this disclosure are delineated as separate operations represented as independent blocks. However, these separately delineated operations should not be construed as necessarily order dependent in their performance. The order in which the processes are described is not intended to be construed as a limitation, and any number of the described process blocks may be combined in any order to implement the process, or an alternate process. Moreover, it is also possible that one or more of the provided operations may be modified or omitted.

The processes are illustrated as a collection of blocks in logical flowcharts, which represent a sequence of operations that can be implemented in hardware, software, or a combination of hardware and software. For discussion purposes, the processes are described with reference to the system shown in FIGS. 1-5. However, the processes may be performed using different architectures and devices.

FIG. 6 is a flowchart illustrating a method 600 for managing permissions to share a session between devices in a shared resource computing (SRC) environment, according to an example embodiment. At block 602, a session operative on the SRC Box 102 is mapped to a graphical representation of the session.

At block 604, the graphical representation of the session is displayed within a graphical user interface (GUI) 210. In one embodiment, the graphical representation of the session is displayed to resemble a room, such as a room in a school building or other building (as shown in FIG. 2). In alternate embodiments, the graphical representation of the session may be displayed in other forms, including, in one example, to resemble a small desktop (as illustrated in FIGS. 4 and 5).

At block 606, a user 108 is mapped to a graphical representation 212 of the user, also referred to as an avatar 212. In one example, each graphical representation 212 of a user is configured to represent a user 108, at least in part for sharing and exchanging sessions operative on the SRC Box 102.

A user 108 may be associated to one or more sessions. At block 608, the relationship between a user 108 and each session that the user is associated to is determined. For example, the user 108 may have read or read/write access to a session, or may have one or more permissions with respect to the session.

In one embodiment, a user 108 may be granted permissions with regard to a session by dragging the graphical representation 212 of the user to the graphical representation of the session within the GUI. For example, an administrator 106 may drag an avatar 212 representing a user 108 to a graphical representation of a session, thereby granting the user 108 access to the session. In alternate embodiments, a user 108 may be granted permissions with regard to a session by other methods (e.g., assignment tables, data mapping, keystrokes, gestures, touch screen, pen, mouse movements, etc.).

Accordingly, permissions held by a user 108 with regard to a session may be terminated by various methods also. In one embodiment, a user's permissions with regard to a session are terminated by dragging the graphical representation 212 of the user away from the graphical representation of the session within the GUI. In alternate embodiments, a user's permissions with regard to a session may be terminated by other methods (e.g., assignment tables, data mapping, keystrokes, gestures, touch screen, pen, mouse movements, etc.).

At block 610 the graphical representation 212 of the user is displayed based on the relationship of the user 108 to a session. In one embodiment, the graphical representation 212 of the user may be displayed in one of a plurality of styles to indicate permissions held by the user 108 with regard to the session. For example, this may include: displaying the graphical representation 212 of the user in a first style when the user holds a first level of permissions with regard to the session, displaying the graphical representation 212 of the user in a second style when the user holds a second level of permissions with regard to the session, or displaying the graphical representation 212 of the user in a third style when the user holds no permissions with regard to the session. The styles used to display the graphical representation 212 of the user may include the use of one or more of colors, highlighting, animation, transparency, size, line style and/or weight, and the like.

FIG. 7 is a flowchart illustrating a method 700 for sharing a session between devices in a SRC environment, according to an example embodiment. At block 702, a user 108 accesses a session operative on a SRC Box 102 from a first device in a SRC environment. For example, the user 108 may access the session from a peripheral device 104 (as shown in FIGS. 1 and 2). In alternate embodiments, the user 108 may access the session from other devices (e.g., the SRC Box, etc.)

At block 704, the accessed session is saved to a saved session. The saved session may comprise the current state of the user's interaction with the session and the current state of the session. For example, the saved session may include one or more applications operative on the session, and the current state of the application(s) or the user's interaction with the application(s). It may also include the user's individual desktop and associated individual settings, or preferences with respect to the session. In alternate embodiments, various aspects of the session and/or application(s) operative on the session may be saved to the saved session.

In one embodiment, the saved session may be saved in the memory 304. In other embodiments, the saved session may be saved to other forms of computer readable storage media (e.g., random access memory (RAM), hard disk drive, portable memory storage device, ZIP drive, optical storage device, digital versatile disk (DVD), compact disk (CD), etc.). In alternate embodiments, the computer readable storage media is located at various local or remote locations, or may be portable.

At block 706, the saved session is transferred to a second device. In one embodiment, the saved session is transferred to the second device by first transferring the saved session from the first device (the original access device) to a portable data storage device (e.g., a memory stick, a “thumb drive,” a mobile device such as a personal digital assistant (PDA) or smart phone, and the like). Then, the saved session is transferred from the portable data storage device to the second device. In another embodiment, the saved session is transferred to the second device by first transferring the saved session from the first device to a remote network device (a storage location on a network, local area network (LAN), wide area network (WAN), the Internet, etc.). Then the saved session is transferred from the remote network device to the second device. In alternate embodiments, the saved session may be transferred to a second device by other methods and/or devices.

In one embodiment, the second device is another peripheral device 104. In alternate embodiments, the second device is another device (e.g., the SRC Box, a portable or mobile device, a remote network device, etc.). In one alternate embodiment, the second device is a remote network device, where the remote network device is hosting the saved session.

At block 708, the saved session is accessed from the second device. In one embodiment, the saved session is operative on the SRC Box 102 when it is accessed from the second device.

### CONCLUSION

The subject matter described above can be implemented in hardware, software, or in both hardware and software. Although implementations of a SRC system have been described in language specific to structural features and/or methodological acts, it is to be understood that the subject matter defined in the appended claims is not necessarily limited to the specific features or acts described above. Rather, the specific features and acts are disclosed as illustrative forms of illustrative implementations of controlling access to resources. For example, the methodological acts need not be performed in the order or combinations described herein, and may be performed in any combination of one or more acts.

1. A system for sharing and exchanging a session between devices in a shared resource computing (SRC) environment, the system comprising:
a SRC Box comprising a common computing resource; and
a plurality of devices coupled to the SRC Box and sharing the common computing resource;
the SRC Box comprising:
a processor;
memory coupled to the processor;
a mapping module stored in the memory and executable on the processor, the mapping module configured to map a graphical representation to each of a plurality of sessions operative on the SRC Box, and to map an avatar to a profile of a user of the system;
a display module stored in the memory and executable on the processor, the display module configured to display the graphical representations within a graphical user interface (GUI); and
a management module stored in the memory and executable on the processor, the management module configured to associate the user to one or more of the plurality of sessions.

2. The system of claim 1, wherein the display module is further configured to display the avatar within the GUI when the user is associated to one or more of the plurality of sessions, the avatar being displayed proximal to or within each graphical representation of a session with which the user is associated.

3. The system of claim 2, wherein the display module is further configured to:
display the avatar in an emphasized manner when the user is authenticated to the session with which the user is associated; and
display the avatar in a de-emphasized manner when the user is not authenticated to the session with which the user is associated.

4. The system of claim 1, wherein the display module is configured to display the graphical representations of the plurality of sessions within the GUI in response to a first input received from the user; and
wherein the display module is configured to display one of the plurality of sessions in a maximized manner within the GUI in response to a second input received from the user, the second input comprising a selection of a graphical representation mapped to the one of the plurality of sessions.

5. The system of claim 1, wherein the display module is further configured to display graphical representations to indicate one or more of:
desktops owned by the user;
desktops created by the user;
desktops which the user has been invited to join; and
desktops which the user has joined.

6. The system of claim 1, wherein the management module is configured to associate the user to the one or more of the plurality of sessions when the avatar is dragged to a graphical representation of the one or more of the plurality of sessions.

7. The system of claim 6, wherein associate the user to the one or more of the plurality of sessions comprises at least one of: providing the user access to resources, authenticating the user, or granting the user one or more permissions with respect to the one or more of the plurality of sessions.

8. The system of claim 1, wherein the management module is configured to create a new session operative on the SRC Box based on input received from the user.

9. The system of claim 1, wherein the management module is configured to log events associated with the plurality of sessions operative on the SRC Box; and
wherein the display module is configured to display notifications to the user based on the events logged.

10. The system of claim 9, wherein the events include one or more of:
a session opened by another user;
a change to a session since the session was last opened by the user;
a session shared between one or more other users; and
an application opened within a session by another user.

11. The system of claim 1, wherein the management module is configured to associate the user to multiple sessions in response to a single user login.

12. A method of managing permissions to share a session between devices in a shared resource computing (SRC) environment, the method comprising:
mapping a session operative on a SRC Box to a graphical representation of the session;
displaying the graphical representation of the session within a graphical user interface (GUI);
mapping a profile of a user to a graphical representation of the user;
determining a relationship of the user to the session; and
displaying the graphical representation of the user within the GUI based on the relationship of the user to the session.

13. The method of claim 12, wherein the displaying the graphical representation of the session comprises displaying the graphical representation to resemble a room, and wherein the user establishes a relationship to the session by moving the graphical representation of the user within the GUI to the graphical representation resembling the room, and wherein the user terminates a relationship with the session by moving the graphical representation of the user away from the graphical representation resembling the room.

14. The method of claim 12, wherein the displaying the graphical representation of the user comprises displaying the graphical representation of the user in one of a plurality of styles to indicate permissions held by the user with regard to the session, the displaying further comprising:
displaying the graphical representation of the user in a first style when the user holds a first level of permissions with regard to the session; or
displaying the graphical representation of the user in a second style when the user holds a second level of permissions with regard to the session.

15. The method of claim 14, further comprising displaying the graphical representation of the user in a third style when the user holds no permissions with regard to the session.

16. The method of claim 12, further comprising receiving an input representing dragging the graphical representation of the user to the representation of the session within the GUI; and in response to receipt of the user input, granting the user permissions with regard to the session.

17. The method of claim 16, wherein granting the user permissions comprises displaying a desktop associated with the session on a display of the user and/or granting the user access to one or more computing resources of the session.

18. The method of claim 12, further comprising receiving an input representing dragging the graphical representation of the user away from the representation of the session within the GUI; and in response to receipt of the user input, terminating the user's permissions with regard to the session.

19. The method of claim 18, wherein terminating the user's permissions comprises terminating a display of a desktop associated with the session on a display of the user and/or terminating the user's access to one or more computing resources of the session.

20. A method for sharing a session between devices in a shared resource computing (SRC) environment, the method comprising:
accessing a session operative on a SRC Box, by a user from a first device;
saving the accessed session to a saved session, the saving comprising capturing a current state of the user's interaction with the session and a current state of the session;
transferring the saved session to a second device; and
accessing the saved session from the second device,
wherein the saved session is operative on the SRC Box after accessing the saved session from the second device.

21. The method of claim 20, wherein the transferring comprises transferring the saved session from the first device to a portable data storage device (actual thumb drive or mobile device), and transferring the saved session from the portable data storage device to the second device.

22. The method of claim 20, wherein the transferring comprises transferring the saved session from the first device to a remote network device (cloud as thumb drive), and transferring the saved session from the remote network device to the second device.

23. The method of claim 20, wherein the second device is a remote network device, the remote network device hosting the saved session.

24. The method of claim 20, wherein the accessing the saved session comprises accessing the saved session from the second device through a remote network device (accessing through the cloud).
